(19) United States
(12) Patent Application Publication
(10) Pub. No.: US 2024/0421898 A1
(43) Pub. Date: Dec. 19, 2024

(54) METHODS, COMMUNICATIONS DEVICES AND INFRASTRUCTURE EQUIPMENT

(71) Applicants: Sony Group Corporation, Tokyo (JP); SONY EUROPE B.V., Weybridge Surrey (GB)

(72) Inventors: Martin Warwick BEALE, Basingstoke (GB); Samuel Asangbeng ATUNGSIRI, Basingstoke (GB)

(73) Assignees: Sony Group Corporation, Tokyo (JP); SONY EUROPE B.V., Weybridge Surrey (GB)

(21) Appl. No.: 18/703,430

(22) PCT Filed: Sep. 20, 2022
(86) PCT No.: PCT/EP2022/076121

§ 371 Date: Apr. 22, 2024

(30) Foreign Application Priority Data
Nov. 4, 2021 (EP) 21206559.3

(51) Int. Cl. H04B 7/185

(52) U.S. Cl. CPC H04B 7/18589; H04B 7/18547; H04B 7/18558

(57) ABSTRACT

A method of operating a communications device for transmitting signals to and/or receiving signals from a non-terrestrial network (NTN) apparatus of a wireless communications network. The communications device acquires information for synchronising a transmission with the NTN apparatus. The communications device estimates a time remaining until an expiry time at which the information for synchronising the transmission with the apparatus will become invalid. The communications device receives, from the NTN apparatus, a biasing signal providing an indication to the communications device to bias an estimate of a time required to communicate the transmission with the NTN apparatus. The communications device determines, based at least in part on the indication provided by the biasing signal, the biased estimate of the time required to communicate the transmission with the NTN apparatus.

### BACKGROUND

### Field of Disclosure

The present disclosure relates to communications devices, infrastructure equipment and methods of operating communications devices and infrastructure equipment.

The present application claims the Paris Convention priority of European patent application number EP21206559.3, the contents of which are hereby incorporated by reference in their entirety.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

Third and fourth generation mobile telecommunication systems, such as those based on the 3GPP defined UMTS and Long Term Evolution (LTE) architecture, are able to support more sophisticated services than simple voice and messaging services offered by previous generations of mobile telecommunication systems. For example, with the improved radio interface and enhanced data rates provided by LTE systems, a user is able to enjoy high data rate applications such as mobile video streaming and mobile video conferencing that would previously only have been available via a fixed line data connection. The demand to deploy such networks is therefore strong and the coverage area of these and future networks, i.e. geographic locations where access to the networks is possible, may be expected to increase ever more rapidly.

Current and future wireless communications networks are expected to routinely and efficiently support communications with a wider range of devices associated with a wider range of data traffic profiles and types than previously developed systems are optimised to support. For example it is expected that future wireless communications networks will be expected to efficiently support communications with devices including reduced complexity devices, machine type communication (MTC) devices, high resolution video displays, virtual reality headsets and so on. Some of these different types of devices may be deployed in very large numbers, for example low complexity devices for supporting the “The Internet of Things”, and may typically be associated with the transmissions of relatively small amounts of data with relatively high latency tolerance.

In view of this there is expected to be a desire for more advanced wireless communications networks, for example those which may be referred to as 5G or new radio (NR) system/new radio access technology (RAT) systems, as well as future iterations/releases of existing systems, to efficiently support connectivity for a wide range of devices associated with different applications and different characteristic data traffic profiles.

One example area of current interest in this regard includes so-called “non-terrestrial networks”, or NTN for short. 3GPP has proposed in Release 15 of the 3GPP specifications to develop technologies for providing coverage by means of one or more antennas mounted on airborne or space-borne vehicles [1].

Non-terrestrial networks may provide service in areas that cannot be covered by terrestrial cellular networks (i.e. those where coverage is provided by means of land-based antennas), such as isolated or remote areas, on board aircraft or vessels) or may provide enhanced service in other areas. The expanded coverage that may be achieved by means of non-terrestrial networks may provide service continuity for machine-to-machine (M2M) or ‘internet of things’ (IoT) devices, or for passengers on board moving platforms (e.g. passenger vehicles such as aircraft, ships, high speed trains, or buses). Other benefits may arise from the use of non-terrestrial networks for providing multicast/broadcast resources for data delivery.

The use of different types of network infrastructure equipment and requirements for coverage enhancement give rise to new challenges for efficiently handling communications in wireless communications systems that need to be addressed.

### SUMMARY OF THE DISCLOSURE

The present disclosure can help address or mitigate at least some of the issues discussed above.

Embodiments can provide a method of operating a communications device for transmitting signals to and/or receiving signals from a non-terrestrial network, NTN, apparatus of a wireless communications network. The communications device acquires information for synchronising a transmission with the NTN apparatus. The transmission with the NTN apparatus is one of an uplink transmission to be transmitted to the NTN apparatus, a downlink transmission to be received from the NTN apparatus, and a sequence of uplink and downlink transmissions to be communicated between the communications device and the NTN apparatus. The communications device estimates a time remaining until an expiry time at which the information for synchronising the transmission with the apparatus will become invalid. The communications device receives, from the NTN apparatus, a biasing signal providing an indication to the communications device to bias an estimate of a time required to communicate the transmission with the NTN apparatus. The communications device determines, based at least in part on the indication provided by the biasing signal, the biased estimate of the time required to communicate the transmission with the NTN apparatus. The communications device determines whether or not to commence the transmission with the NTN apparatus before the expiry time based on the estimated time remaining until the expiry time and the biased estimate of the time required to communicate the transmission with the NTN apparatus.

The indication provided by the biasing signal enables the wireless communications network to influence or modify an estimate of a time required to communicate the transmission with the NTN apparatus. The indication provided by the biasing signal may reflect network conditions such as signalling load in the wireless communications network, interference conditions in the wireless communications network, the occurrence of an emergency scenario and so on, as will be explained in more detail below. Therefore, through the biasing signal, the wireless communications network can influence the decision of whether or not to commence the transmission with the NTN apparatus before the expiry time. The indication provided by the biasing signal can be used to increase an accuracy of the estimate and/or to reflect preferences of the wireless communications network. As will become apparent from the example embodiments described below, the above method can provide an increased communications efficiency in a non-terrestrial wireless communications network.

Respective aspects and features of the present disclosure are defined in the appended claims.

It is to be understood that both the foregoing general description and the following detailed description are exemplary, but are not restrictive, of the present technology. The described embodiments, together with further advantages, will be best understood by reference to the following detailed description taken in conjunction with the accompanying drawings.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings wherein like reference numerals designate identical or corresponding parts throughout the several views, and wherein:

FIG. 1 schematically represents some aspects of an LTE-type wireless telecommunication system which may be configured to operate in accordance with certain embodiments of the present disclosure;

FIG. 2 schematically represents some aspects of a new radio access technology (RAT) wireless telecommunications system which may be configured to operate in accordance with certain embodiments of the present disclosure;

FIG. 3 is a schematic block diagram of an example infrastructure equipment and communications device which may be configured to operate in accordance with certain embodiments of the present disclosure;

FIG. 4 is reproduced from [1], and illustrates a first example of a non-terrestrial network (NTN) featuring an access networking service based on a satellite/aerial platform with a bent pipe payload;

FIG. 5 is reproduced from [1], and illustrates a second example of an NTN featuring an access networking service based on a satellite/aerial platform that incorporates a gNodeB;

FIG. 6 schematically shows an example of a wireless communications system comprising an NTN part and a terrestrial network (TN) part which may be configured to operate in accordance with embodiments of the present disclosure;

FIG. 7 is a signalling diagram illustrating communications between a communications device and a non-terrestrial network apparatus to determine whether or not there is sufficient time to communicate a sporadic short transmission with the non-terrestrial network apparatus;

FIG. 8 is a schematic diagram illustrating a communications device determining whether or not there is sufficient time to communicate a transmission with a non-terrestrial network apparatus; and

FIG. 9 is a part schematic, part message signalling diagram representation of a wireless communications network comprising a communications device and a non-terrestrial network apparatus in accordance with embodiments of the present technique.

### DETAILED DESCRIPTION OF THE EMBODIMENTS

### Long Term Evolution Advanced Radio Access Technology (4G)

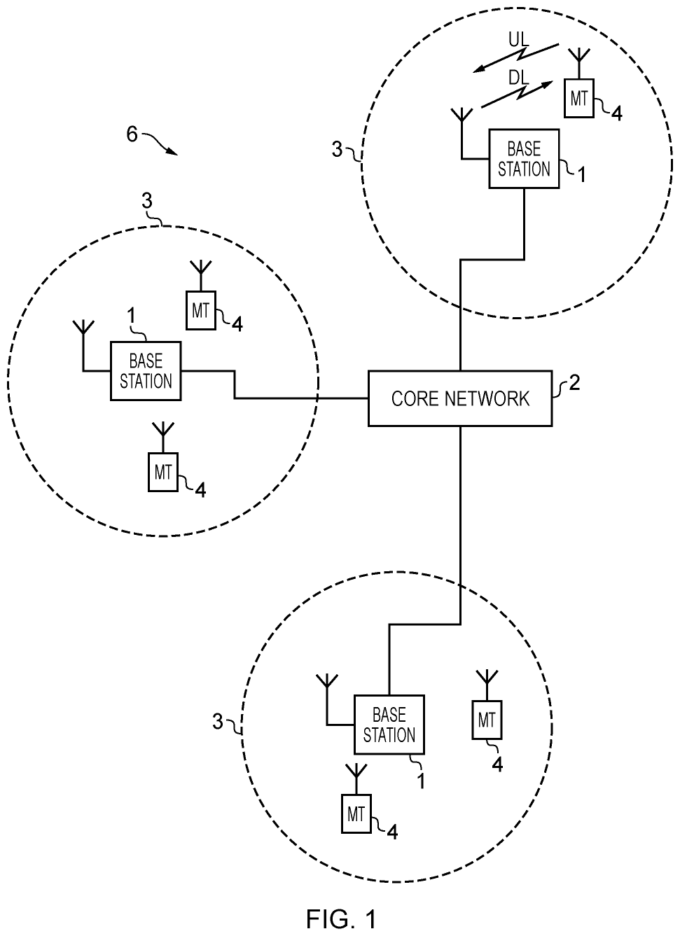

FIG. 1 provides a schematic diagram illustrating some basic functionality of a mobile telecommunications network/system 6 operating generally in accordance with LTE principles, but which may also support other radio access technologies, and which may be adapted to implement embodiments of the disclosure as described herein. Various elements of FIG. 1 and certain aspects of their respective modes of operation are well-known and defined in the relevant standards administered by the 3GPP (RTM) body, and also described in many books on the subject, for example, Holma H. and Toskala A [2]. It will be appreciated that operational aspects of the telecommunications networks discussed herein which are not specifically described (for example in relation to specific communication protocols and physical channels for communicating between different elements) may be implemented in accordance with any known techniques, for example according to the relevant standards and known proposed modifications and additions to the relevant standards.

The network 6 includes a plurality of base stations 1 connected to a core network 2. Each base station provides a coverage area 3 (i.e. a cell) within which data can be communicated to and from communications devices 4. Although each base station 1 is shown in FIG. 1 as a single entity, the skilled person will appreciate that some of the functions of the base station may be carried out by disparate, inter-connected elements, such as antennas (or antennae), remote radio heads, amplifiers, etc. Collectively, one or more base stations may form a radio access network.

Data is transmitted from base stations 1 to communications devices 4 within their respective coverage areas 3 via a radio downlink (DL). Data is transmitted from communications devices 4 to the base stations 1 via a radio uplink (UL). The core network 2 routes data to and from the communications devices 4 via the respective base stations 1 and provides functions such as authentication, mobility management, charging and so on. Terminal devices may also be referred to as mobile stations, user equipment (UE), user terminal, mobile radio, communications device, and so forth. Services provided by the core network 2 may include connectivity to the internet or to external telephony services. The core network 2 may further track the location of the communications devices 4 so that it can efficiently contact (i.e. page) the communications devices 4 for transmitting downlink data towards the communications devices 4.

Base stations, which are an example of network infrastructure equipment, may also be referred to as transceiver stations, nodeBs, e-nodeBs, eNB, g-nodeBs, gNB and so forth. In this regard different terminology is often associated with different generations of wireless telecommunications systems for elements providing broadly comparable functionality. However, certain embodiments of the disclosure may be equally implemented in different generations of wireless telecommunications systems, and for simplicity certain terminology may be used regardless of the underlying network architecture. That is to say, the use of a specific term in relation to certain example implementations is not intended to indicate these implementations are limited to a certain generation of network that may be most associated with that particular terminology.

### New Radio Access Technology (5G)

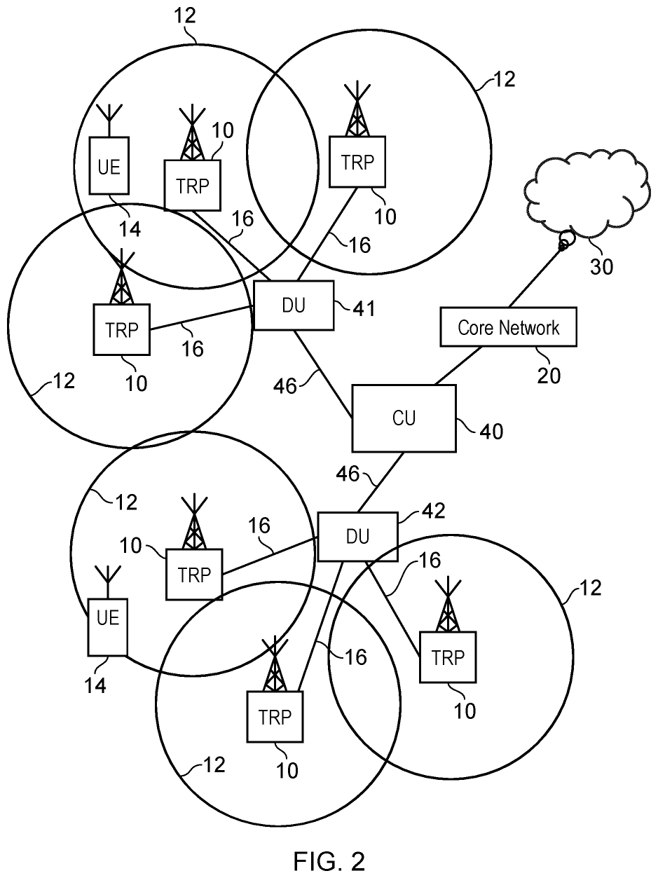

An example configuration of a wireless communications network which uses some of the terminology proposed for and used in NR and 5G is shown in FIG. 2. In FIG. 2 a plurality of transmission and reception points (TRPs) 10 are connected to distributed control units (DUs) 41, 42 by a connection interface represented as a line 16. Each of the TRPs 10 is arranged to transmit and receive signals via a wireless access interface within a radio frequency bandwidth available to the wireless communications network. Thus, within a range for performing radio communications via the wireless access interface, each of the TRPs 10, forms a cell of the wireless communications network as represented by a circle 12. As such, wireless communications devices 14 which are within a radio communications range provided by the cells 12 can transmit and receive signals to and from the TRPs 10 via the wireless access interface. Each of the distributed units 41, 42 are connected to a central unit (CU) 40 (which may be referred to as a controlling node) via an interface 46. The central unit 40 is then connected to the core network 20 which may contain all other functions required to transmit data for communicating to and from the wireless communications devices and the core network 20 may be connected to other networks 30.

The elements of the wireless access network shown in FIG. 2 may operate in a similar way to corresponding elements of an LTE network as described with regard to the example of FIG. 1. It will be appreciated that operational aspects of the telecommunications network represented in FIG. 2, and of other networks discussed herein in accordance with embodiments of the disclosure, which are not specifically described (for example in relation to specific communication protocols and physical channels for communicating between different elements) may be implemented in accordance with any known techniques, for example according to currently used approaches for implementing such operational aspects of wireless telecommunications systems, e.g. in accordance with the relevant standards.

The TRPs 10 of FIG. 2 may in part have a corresponding functionality to a base station or eNodeB of an LTE network. Similarly, the communications devices 14 may have a functionality corresponding to the UE devices 4 known for operation with an LTE network. It will be appreciated therefore that operational aspects of a new RAT network (for example in relation to specific communication protocols and physical channels for communicating between different elements) may be different to those known from LTE or other known mobile telecommunications standards. However, it will also be appreciated that each of the core network component, base stations and communications devices of a new RAT network will be functionally similar to, respectively, the core network component, base stations and communications devices of an LTE wireless communications network.

In terms of broad top-level functionality, the core network 20 connected to the new RAT telecommunications system represented in FIG. 2 may be broadly considered to correspond with the core network 2 represented in FIG. 1, and the respective central units 40 and their associated distributed units/TRPs 10 may be broadly considered to provide functionality corresponding to the base stations 1 of FIG. 1. The term network infrastructure equipment/access node may be used to encompass these elements and more conventional base station type elements of wireless telecommunications systems. Depending on the application at hand the responsibility for scheduling transmissions which are scheduled on the radio interface between the respective distributed units and the communications devices may lie with the controlling node/central unit and/or the distributed units/TRPs. A communications device 14 is represented in FIG. 2 within the coverage area of the first communication cell 12. This communications device 14 may thus exchange signalling with the first central unit 40 in the first communication cell 12 via one of the distributed units/TRPs 10 associated with the first communication cell 12.

It will further be appreciated that FIG. 2 represents merely one example of a proposed architecture for a new RAT based telecommunications system in which approaches in accordance with the principles described herein may be adopted, and the functionality disclosed herein may also be applied in respect of wireless telecommunications systems having different architectures.

Thus, certain embodiments of the disclosure as discussed herein may be implemented in wireless telecommunication systems/networks according to various different architectures, such as the example architectures shown in FIGS. 1 and 2. It will thus be appreciated the specific wireless telecommunications architecture in any given implementation is not of primary significance to the principles described herein. In this regard, certain embodiments of the disclosure may be described generally in the context of communications between network infrastructure equipment/access nodes and a communications device, wherein the specific nature of the network infrastructure equipment/access node and the communications device will depend on the network infrastructure for the implementation at hand. For example, in some scenarios the network infrastructure equipment/access node may comprise a base station, such as an LTE-type base station 1 as shown in FIG. 1 which is adapted to provide functionality in accordance with the principles described herein, and in other examples the network infrastructure equipment may comprise a control unit/controlling node 40 and/or a TRP 10 of the kind shown in FIG. 2 which is adapted to provide functionality in accordance with the principles described herein.

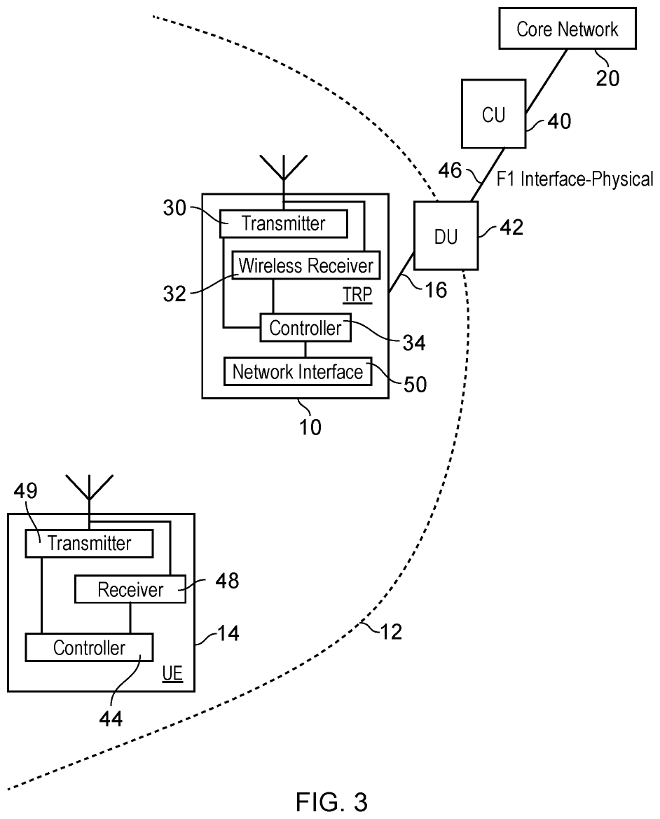

A more detailed diagram of some of the components of the network shown in FIG. 2 is provided by FIG. 3. In FIG. 3, a TRP 10 as shown in FIG. 2 comprises, as a simplified representation, a wireless transmitter 30, a wireless receiver 32 and a controller or controlling processor 34 which may operate to control the transmitter 30 and the wireless receiver 32 to transmit and receive radio signals to one or more UEs 14 within a cell 12 formed by the TRP 10. As shown in FIG. 3, an example UE 14 is shown to include a corresponding transmitter 49, a receiver 48 and a controller 44 which is configured to control the transmitter 49 and the receiver 48 to transmit signals representing uplink data to the wireless communications network via the wireless access interface formed by the TRP 10 and to receive downlink data as signals transmitted by the transmitter 30 and received by the receiver 48 in accordance with the conventional operation.

The transmitters 30, 49 and the receivers 32, 48 (as well as other transmitters, receivers and transceivers described in relation to examples and embodiments of the present disclosure) may include radio frequency filters and amplifiers as well as signal processing components and devices in order to transmit and receive radio signals in accordance for example with the 5G/NR standard. The controllers 34, 44 (as well as other controllers described in relation to examples and embodiments of the present disclosure) may be, for example, a microprocessor, a CPU, or a dedicated chipset, etc., configured to carry out instructions which are stored on a computer readable medium, such as a non-volatile memory. The processing steps described herein may be carried out by, for example, a microprocessor in conjunction with a random access memory, operating according to instructions stored on a computer readable medium. The transmitters, the receivers and the controllers are schematically shown in FIG. 3 as separate elements for ease of representation. However, it will be appreciated that the functionality of these elements can be provided in various different ways, for example using one or more suitably programmed programmable computer(s), or one or more suitably configured application-specific integrated circuit(s)/circuitry/chip(s)/chipset(s). As will be appreciated the infrastructure equipment/TRP/base station as well as the UE/communications device will in general comprise various other elements associated with its operating functionality.

As shown in FIG. 3, the TRP 10 also includes a network interface 50 which connects to the DU 42 via a physical interface 16. The network interface 50 therefore provides a communication link for data and signalling traffic from the TRP 10 via the DU 42 and the CU 40 to the core network 20.

The interface 46 between the DU 42 and the CU 40 is known as the F1 interface which can be a physical or a logical interface, and may be formed from a fibre optic or other wired or wireless high bandwidth connection. In one example the connection 16 from the TRP 10 to the DU 42 is via fibre optic. The connection between a TRP 10 and the core network 20 can be generally referred to as a backhaul, which comprises the interface 16 from the network interface 50 of the TRP 10 to the DU 42 and the F1 interface 46 from the DU 42 to the CU 40.

### Non-Terrestrial Networks (NTNs)

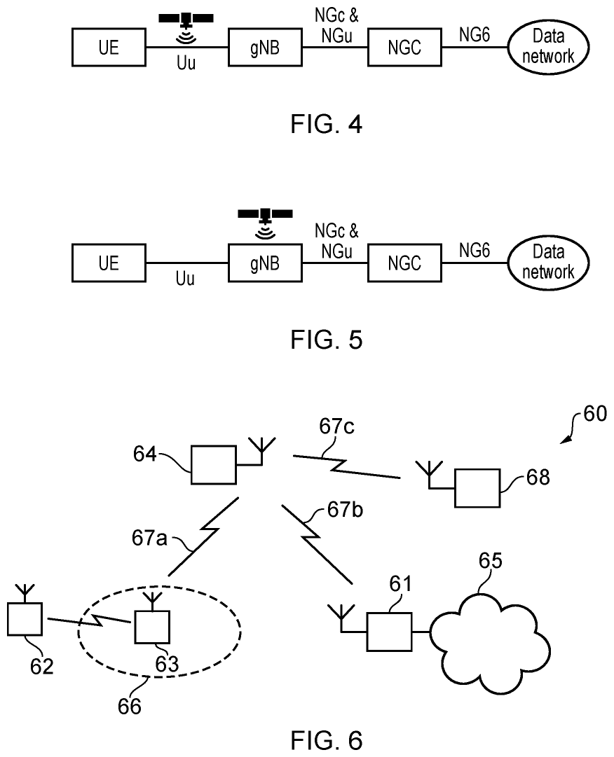

An overview of NR-NTN can be found in [1], and much of the following wording, along with FIGS. 4 and 5, has been reproduced from that document as a way of background.

As a result of the wide service coverage capabilities and reduced vulnerability of space/airborne vehicles to physical attacks and natural disasters, Non-Terrestrial Networks are expected to:
foster the roll out of 5G service in un-served areas that cannot be covered by terrestrial 5G networks (isolated/remote areas, on board aircrafts or vessels) and underserved areas (e.g. sub-urban/rural areas) to upgrade the performance of limited terrestrial networks in a cost effective manner;
reinforce the 5G service reliability by providing service continuity for M2M/IoT devices or for passengers on board moving platforms (e.g. passenger vehicles-aircraft, ships, high speed trains, bus) or ensuring service availability anywhere especially for critical communications, future railway/maritime/aeronautical communications; and to
enable 5G network scalability by providing efficient multicast/broadcast resources for data delivery towards the network edges or even user terminal.

The benefits relate to either Non-Terrestrial Networks operating alone or to integrated terrestrial and Non-Terrestrial networks. They will impact at least coverage, user bandwidth, system capacity, service reliability or service availability, energy consumption and connection density. A role for Non-Terrestrial Network components in the 5G system is expected for at least the following verticals: transport, Public Safety, Media and Entertainment, eHealth, Energy, Agriculture, Finance and Automotive. It should also be noted that the same NTN benefits apply to other technologies such as 4G and/or LTE technologies, and that while NR is sometimes referred to in the present disclosure, the teachings and techniques presented herein are equally applicable to other technologies such as 4G and/or LTE and/or NB-IoT.

FIG. 4 illustrates a first example of an NTN architecture based on a satellite/aerial platform with a bent pipe payload, meaning that the signal received from the UE is simply reflected and sent back down to Earth by the satellite/aerial platform, with only frequency or amplification changing; i.e. acting like a pipe with a u-bend. In this example NTN, the satellite or the aerial platform will therefore relay a “satellite friendly” NR (or LTE) signal between the gNodeB (or eNodeB) and UEs in a transparent manner.

FIG. 5 illustrates a second example of an NTN architecture based on a satellite/aerial platform comprising a gNodeB (or eNodeB in the examples of the present disclosure) which may be referred to as non-terrestrial infrastructure equipment. In this example NTN, the satellite or aerial platform carries a full or part of a gNodeB/eNodeB to generate or receive an NR (or LTE) signal to/from the UEs. For example, in addition to frequency conversion and amplification, the satellite/aerial platform may also decode a received signal. This requires the satellite or aerial platform to have sufficient on-board processing capabilities to be able to include a gNodeB or eNodeB functionality.

FIG. 6 schematically shows an example of a wireless communications system 60 which may be configured to operate in accordance with embodiments of the present disclosure. The wireless communications system 60 in this example is based broadly around an LTE-type or 5G-type architecture. Many aspects of the operation of the wireless communications system/network 60 are known and understood and are not described here in detail in the interest of brevity. Operational aspects of the wireless communications system 60 which are not specifically described herein may be implemented in accordance with any known techniques, for example according to the current LTE standards or the current 5G standards.

The wireless communications system 60 comprises a core network part 65 (which may be a 4G core network or a 5G core network) in communicative connection with a radio network part. The radio network part comprises a base station (g-node B) 61 connected to a non-terrestrial network part 64. The non-terrestrial network part 64 may be an example of infrastructure equipment. Alternatively, or in addition, the non-terrestrial network part 64 may be mounted on a satellite vehicle or on an airborne vehicle.

The non-terrestrial network part 64 may communicate with a communications device 63, located within a cell 66, by means of a wireless access interface provided by a wireless communications link 67a. For example, the cell 66 may correspond to the coverage area of a spot beam generated by the non-terrestrial network part 64. The boundary of the cell 66 may depend on an altitude of the non-terrestrial network part 64 and a configuration of one or more antennas of the non-terrestrial network part 64 by which the non-terrestrial network part 64 transmits and receives signals on the wireless access interface.

The non-terrestrial network part 64 may be a satellite in an orbit with respect to the Earth, or may be mounted on such a satellite. For example, the satellite may be in a geo-stationary earth orbit (GEO) such that the non-terrestrial network part 64 does not move with respect to a fixed point on the Earth's surface.

The geo-stationary earth orbit may be approximately 36,786 km above the Earth's equator. The satellite may alternatively be in a low-earth orbit (LEO), in which the non-terrestrial network part 64 may complete an orbit of the Earth relatively quickly, thus providing moving cell coverage. Alternatively, the satellite may be in a non-geostationary orbit (NGSO), so that the non-terrestrial network part 64 moves with respect to a fixed point on the Earth's surface. The non-terrestrial network part 64 may be an airborne vehicle such as an aircraft, or may be mounted on such a vehicle. The airborne vehicle (and hence the non-terrestrial network part 64) may be stationary with respect to the surface of the Earth or may move with respect to the surface of the Earth.

In FIG. 6, the terrestrial station 61 is shown as ground-based, and connected to the non-terrestrial network part 64 by means of a wireless communications link 67b. The non-terrestrial network part 64 receives signals representing downlink data transmitted by the base station 61 on the wireless communications link 67b and, based on the received signals, transmits signals representing the downlink data via the wireless communications link 67a providing the wireless access interface for the communications device 63. Similarly, the non-terrestrial network part 64 receives signals representing uplink data transmitted by the communications device 63 via the wireless access interface comprising the wireless communications link 67a and transmits signals representing the uplink data to the terrestrial station 61 on the wireless communications link 67b. The wireless communications links 67a, 67b may operate at a same frequency, or may operate at different frequencies.

The extent to which the non-terrestrial network part 64 processes the received signals may depend upon a processing capability of the non-terrestrial network part 64. For example, the non-terrestrial network part 64 may receive signals representing the downlink data on the wireless communication link 67b, amplify them and (if needed) re-modulate onto an appropriate carrier frequency for onwards transmission on the wireless access interface provided by the wireless communications link 67a. Alternatively, the non-terrestrial network part 64 may be configured to decode the signals representing the downlink data received on the wireless communication link 67b into un-encoded downlink data, re-encode the downlink data and modulate the encoded downlink data onto the appropriate carrier frequency for onwards transmission on the wireless access interface provided by the wireless communications link 67a.

The non-terrestrial network part 64 may be configured to perform some of the functionality conventionally carried out by a base station (e.g. a gNodeB or an eNodeB), such as base station 1 as shown in FIG. 1. In particular, latency-sensitive functionality (such as acknowledging a receipt of the uplink data, or responding to a RACH request) may be performed by the non-terrestrial network part 64 partially implementing some of the functions of a base station.

As mentioned above, a base station may be co-located with the non-terrestrial network part 64; for example, both may be mounted on the same satellite vehicle or airborne vehicle, and there may be a wireless connection providing the coupling between the terrestrial station 61 and the base station co-located on the non-terrestrial network part 64. In such co-located arrangements, a wireless communications feeder link between the terrestrial station 61 and another terrestrial station (not shown) may provide connectivity between the terrestrial station 61 (co-located with the non-terrestrial network part 64) and the core network part 65.

The terrestrial station 61 may be an NTN Gateway that is configured to transmit signals to the non-terrestrial network part 64 via the wireless communications link 67b and to communicate with the core network part 65. That is, in some examples the terrestrial station 61 may not include base station functionality. For example, if the base station is co-located with the non-terrestrial network part 64, as described above, the terrestrial station 61 does not implement base station functionality. In other examples, the base station may be co-located with the NTN Gateway in the terrestrial station 61, such that the terrestrial station 61 is capable of performing base station (e.g. gNodeB or eNodeB) functionality.

In some examples, even if the base station is not co-located with the non-terrestrial network part 64 (such that the base station functionality is implemented by a ground-based component), the terrestrial station 61 may not necessarily implement the base station functionality. In other words, the base station (e.g. gNodeB or eNodeB) may not be co-located with the terrestrial station 61 (NTN Gateway). In this manner, the terrestrial station 61 (NTN Gateway) transmits signals received from the non-terrestrial network part 64 to a base station (not shown in FIG. 6). In such an example, the base station (e.g. gNodeB or eNodeB) may be considered as being part of core network part 65, or may be separate (not shown in FIG. 6) from the core network part 65 and located logically between the terrestrial station 61 (NTN Gateway) and the core network part 65.

In some cases, the communications device 63 shown in FIG. 6 may be configured to act as a relay node. That is, it may provide connectivity to one or more terminal devices such as the terminal device 62. When acting as a relay node, the communications device 63 transmits and receives data to and from the terminal device 62, and relays it, via the non-terrestrial network part 64 to the terrestrial station 61. The communications device 63, acting as a relay node, may thus provide connectivity to the core network part 65 for terminal devices which are within a transmission range of the communications device 63.

In some cases, the non-terrestrial network part 64 is also connected to a ground station 68 via a wireless link 67c. The ground station may for example be operated by the satellite operator (which may be the same as the mobile operator for the core and/or radio network or may be a different operator) and the link 67c may be used as a management link and/or to exchange control information. In some cases, once the non-terrestrial network part 64 has identified its current position and velocity, it can send position and velocity information to the ground station 68. The position and velocity information may be shared as appropriate, e.g. with one or more of the UE 63, terrestrial station 61 and base station, for configuring the wireless communication accordingly (e.g. via links 67a and/or 67b).

It will be apparent to those skilled in the art that many scenarios can be envisaged in which the combination of the communications device 63 and the non-terrestrial network part 64 can provide enhanced service to end users. For example, the communications device 63 may be mounted on a passenger vehicle such as a bus or train which travels through rural areas where coverage by terrestrial base stations may be limited. Terminal devices on the vehicle may obtain service via the communications device 63 acting as a relay, which communicates with the non-terrestrial network part 64.

A challenge of conventional cellular communications techniques may be the relatively high rate at which cell changes occur for the communications device 63 obtaining service from one or more non-terrestrial network parts. For example, where the non-terrestrial network part 64 is mounted on a LEO satellite, the non-terrestrial network part 64 may complete an orbit of the Earth in around 90 minutes; the coverage of a cell generated by the non-terrestrial network part 64 will move very rapidly, with respect to a fixed observation point on the surface of the Earth. Similarly, it may be expected in some cases that the communications device 63 may be mounted on an airborne vehicle itself, having a ground speed of several hundreds of kilometres per hour.

A study has been completed by 3GPP on solutions for NR to support NTN, as detailed in [3]. This study [3] focuses on use cases for satellite access in 5G and service requirements, as well as on evaluating solutions and impacts on RAN protocols and architecture. The study resulted in a new work item [4] that has already been started in RAN working groups to specify the enhancements identified for NR, especially for satellite access via transparent payload LEO and GEO satellites with implicit compatibility to support high altitude platform stations (HAPS) and air to ground (ATG) scenarios.

In addition, 3GPP initiated a new study item [5] for deploying narrowband internet of things (NB-IoT)/enhanced machine type communications (eMTC) over NTN, with the following justifications as detailed in [5]:
IoT operation is critical in remote areas with low/no cellular connectivity for many different industries, including for example:
   Transportation (maritime, road, rail, air) & logistics;
   Solar, oil & gas harvesting;
   Utilities;
   Farming;
   Environment monitoring; and
   Mining etc.; and
From the objectives perspective, at least the following items are addressed in [6]:
   Aspects related to random access procedure/signals [RAN1, RAN2];
   Mechanisms for time/frequency adjustment including Timing Advance, and UL frequency compensation indication [RAN1, RAN2];
   Timing offset related to scheduling and hybrid automatic repeat request acknowledgement (HARQ-ACK) feedback [RAN1, RAN2];
   Aspects related to HARQ operation [RAN2, RAN1];
   General aspects related to timers (e.g. scheduling requests (SR), discontinuous reception (DRX), etc.) [RAN2];
   RAN2 aspects related to idle mode and connected mode mobility [RAN2];
      Radio link failure (RLF)-based for NB-IoT;
      Handover-based for eMTC;
   System information enhancements [RAN2]; and
   Tracking area enhancements [RAN2].

An outline of studies by 3GPP into how to adapt Rel-16 NB-IoT and eMTC for operation over NTN can be found in [6]. The benefits of ubiquitous coverage are key for wide area IoT services.

### Sporadic Short Transmissions

In Release 17 of the 3GPP standards, an IoT-NTN work item is targeted at the support of “sporadic short transmissions”.

A “sporadic short transmission” is a transmission whose length is less than the time for which satellite ephemeris information read on SIB is valid. It will be appreciated that “satellite ephemeris information” is information pertaining to the orbit of a satellite about the earth. For example, satellite ephemeris information may include, but is not limited to, information regarding the trajectory, speed or position of a satellite relative to the earth.

The “sporadic” nature of a sporadic short transmission refers to the time between when sporadic short transmissions are transmitted or received. This time gap is variable and, in some circumstances, long for a sporadic short transmission. For example, the time gap between sporadic short transmissions is generally longer than the time duration of one of the sporadic short transmissions itself.

Sporadic short transmissions may be uplink transmissions, downlink transmissions, or a sequence of uplink and/or downlink transmissions. In one example, a sporadic short transmission may be a Physical Uplink Shared Channel (PUSCH) transmission. In another example, a sporadic short transmission may be a sequence of uplink and downlink messages for transmitting higher layer application data. In one such example, a sporadic short transmission may include:
A Physical Random Access Channel (PRACH) transmission for transmitting a random access preamble,
A Physical Downlink Control Channel (PDCCH) transmission and a Physical Downlink Shared Channel (PDSCH) transmission, for transmitting a random access response,
A PUSCH transmission for transmitting an RRC connection request (message 3),
A PDCCH transmission and a PDSCH transmission, for transmitting an RRC connection setup,
A PDCCH transmission and a PUSCH transmission for transmitting an application layer message, and
A PDCCH transmission and a PDSCH transmission for transmitting an application layer response.

A number of agreements have been reached in the IoT-NTN work item as outlined in [7]. These agreements include:
For sporadic short transmissions, a UE in RRC_CONNECTED should go back to idle mode and re-acquire a GNSS position fix if GNSS becomes outdated.
Satellite ephemeris read on SIB are valid for the duration of sporadic short transmission in RRC_CONNECTED.
Common Timing Advance (TA) parameters if indicated and read on SIB are valid for the duration of sporadic short transmission in RRC_CONNECTED. It will be appreciated that duration of the short transmission is not longer than the “validity timer for uplink synchronisation” referred to in the WID objective.
The validity timer of uplink synchronisation is configured by the network. It is for further study whether a single validity timer or separate validity timers are used for satellite ephemeris and common TA parameters
A UE in RRC_IDLE reads the satellite ephemeris on SIB and the common TA parameters if indicated on SIB and (re-)start the validity timer(s) for uplink synchronisation before moving to RRC_CONNECTED. Details of the precise (re-)start time for the validity timer for UL synchronisation to ensure a common understanding between gNB and UE are for further study.
Other signalling details for validity timer will be agreed by RAN2.

As mentioned above, it has been agreed that satellite ephemeris read on SIB are valid for the duration of sporadic short transmission in RRC_CONNECTED. If the validity timer expires, it has been suggested that a UE performs one of the following procedures:
The UE moves to IDLE mode. In this case, if the UE was transmitting an uplink transmission, then the UE would be required to perform another RRC connection in order to re-transmit the uplink transmission. The UE may need to signal to the network that it intends to transition to IDLE mode. Furthermore, signalling will be required between the UE and the network to start another RRC connection. As will be appreciated, such additional signalling not only implies an increased signalling burden in the network but may also lead to increased UE power consumption.
The UE declares RLF (radio link failure). In this case, if the UE was transmitting an uplink transmission, then the uplink transmission would be interrupted by the RLF. The process of RLF requires signalling including possible signalling to indicate imminent loss of uplink synchronisation (see co-pending European patent application number: 21206300.2) and signalling to recover from RLF (for example, signalling to indicate to the network that the UE has re-acquired uplink synchronisation). Furthermore, the RLF process may take a significant period of time.

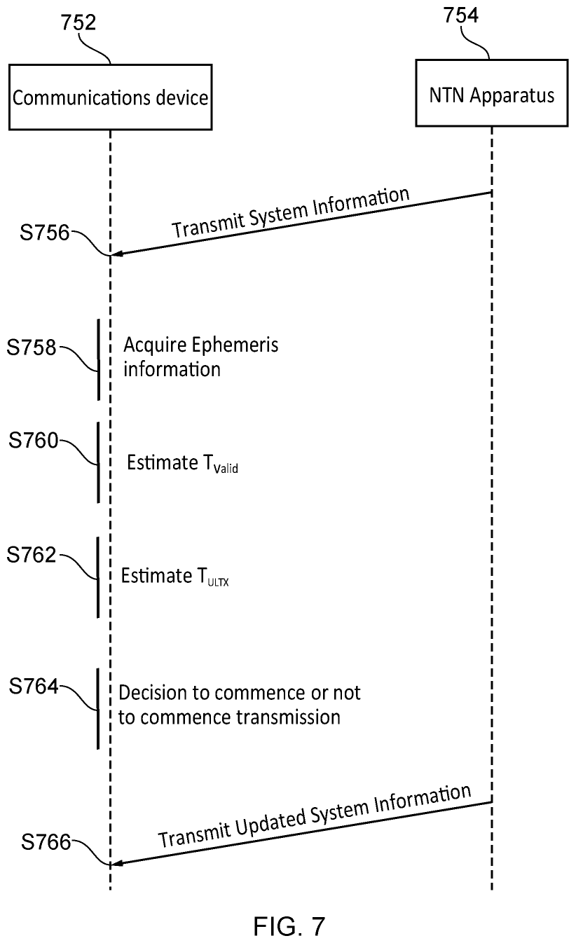

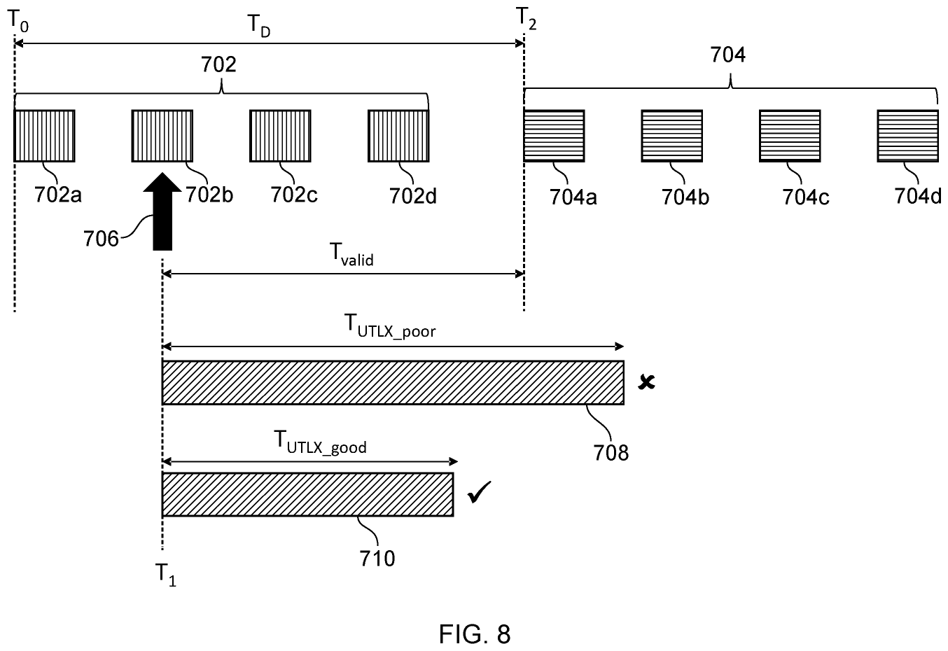

As discussed above, UE transmissions may be interrupted if a validity timer expires. In order to improve communications efficiency, it is desirable to reduce the number of transmissions which are interrupted. One approach suggests that the UE determines whether or not it has sufficient time to communicate a sporadic short transmission before the validity timer expires ([9]). In this approach, the UE commences the sporadic short transmission if it determines that there is sufficient time before the validity timer expires for communicating the sporadic short transmission. Conversely, if the UE determines that there is not sufficient time to communicate the sporadic short transmission before the validity timer expires, then the UE refrains from commencing the sporadic short transmission. An example of this approach is described below with reference to FIG. 7 and FIG. 8.

### Procedure for Transmission of Uplink Sporadic Short Transmission

FIG. 7 and FIG. 8 are schematic representations illustrating a procedure of a communications device determining whether or not there is sufficient time to transmit a sporadic short transmission before a validity timer expires. In this example, the sporadic short transmission is a PUSCH transmission. As shown in FIG. 7, a communications device 752 (such as a UE) communicates with a non-terrestrial network, NTN, apparatus 754 forming part of a wireless communications network. The communications device 752 is configured to transmit signals to and/or to receive signals from the NTN apparatus 754. The NTN apparatus 754 (which may correspond to NTN part 64 of the example wireless communications system of FIG. 6) may be a satellite, an airborne vehicle, an aerial platform, or the like, or may alternatively be mounted upon a satellite, an airborne vehicle, an aerial platform, or the like. Furthermore, the NTN apparatus 754 may be an infrastructure equipment (e.g. a gNB, eNB or base station) of the wireless communications network—i.e. the NTN apparatus 754 may implement functionality of a base station or gNB or the like. Alternatively, such an infrastructure equipment may be mounted upon or otherwise coupled to or carried by the NTN apparatus 754. Alternatively, the NTN apparatus 754 may relay signals between the communications device 752 and an infrastructure equipment, where such an infrastructure equipment may be a terrestrial (ground-based) infrastructure equipment.

As shown in FIG. 7, at step S756, the NTN apparatus 754 transmits system information to the communications device 752. The transmission of system information in step 756 of FIG. 7 is represented in FIG. 8 as a transmission of a set 702 of repetitions of a first system information block (SIB) including a first 702a, second 702b, third 702c, and fourth 702d repetition with the first repetition 702a starting at T₀. Each repetition of the set 702 of repetitions of the first SIB indicates the same ephemeris information of the NTN apparatus 754. As mentioned previously, the ephemeris information may include information regarding the orbit of the NTN apparatus 754. It will be appreciated that the communications device 752 may receive other SIBs (not shown in FIG. 8) as part of the system information which do not include ephemeris information but include, for example, information for initial access and/or PRACH parameters.

Still referring to FIG. 8, the ephemeris information is valid for a time T_{D} which will be referred to as the “ephemeris validity duration” The ephemeris validity duration is a time indicating a duration for which the ephemeris information is valid and may, for example, extend from the time T₀ at which the ephemeris information is transmitted to the communications device 752 for the first time until a time T₂ at which updated ephemeris information is transmitted to the communications device 752. The time T₂ therefore represents a time at which the ephemeris information transmitted in the set 702 of repetitions of the first SIB becomes invalid. The time T₂ may therefore be referred to as an “expiry time” or a time at which a validity timer expires.

Returning to FIG. 7, the transmission of updated system information including the updated ephemeris information is performed at step S766. In FIG. 8, the updated system information is represented by as a transmission of a set 704 of repetitions of a second SIB including a first 704a, second 704b, third 704c, and fourth 704d repetition with the first repetition 704a of the set 704 of repetitions of the second SIB starting at T₂. Each repetition in the set 704 of the second SIB indicates the same updated ephemeris information. The updated ephemeris information may include updated information regarding the orbit of the NTN apparatus 754. The NTN apparatus 754 may update information regarding its orbit for any one of a number of reasons known to one skilled in the art. For example, the NTN apparatus 754 may have adjusted its orbit and may have updated the ephemeris information in response to determining the new orbit. In another example, the ephemeris information may be based on a theoretical orbit followed by the NTN apparatus 754 and the ephemeris information is updated to account for differences between the theoretical orbit and a real orbit actually followed by the NTN apparatus 754. It will be appreciated that the communications device 752 may receive other SIBs (not shown in FIG. 8) as part of the updated system information which do not include updated ephemeris information but include, for example, information for initial access and/or PRACH parameters.

Returning to FIG. 7, the communications device 752 acquires the ephemeris information indicated by the system information in step S758. This acquisition of the ephemeris information is shown by arrow 706 in FIG. 8. To acquire, the ephemeris information, the communications device 752 receives and reads the second repetition 702b of the set 702 of repetitions of the first SIB. It will, however, be appreciated that the communications device 752 may have acquired the ephemeris information of the NTN apparatus 754 from any one of the set 702 of repetitions of the first SIB. In this example, the communications device 752 may have determined to read the ephemeris information from the second repetition 702b of the set 702 of repetitions of the first SIB because, for example, the communications device 752 determines, at a time between the transmission of the first repetition 702a and the second repetition 702b, that it has uplink data to transmit to the NTN apparatus 754.

As will be appreciated from FIG. 8, a time remaining to transmit the uplink data between acquiring the ephemeris information during the second repetition 702b of the first SIB at time T₁ and the expiry of the ephemeris information at time T₂ is T_{valid}, which may alternatively be referred to as a time for which the ephemeris information remains valid As mentioned above, the time T₂ represents a time at which a validity timer expires. Accordingly, references to “validity timer” may be referring to either T_{D} or T_{valid}.

In order for the communications device 752 to determine that there is sufficient time remaining to transmit the uplink data between reading the ephemeris information during the second repetition 702b at time T₁ and the expiry of the ephemeris information at time T₂, then the condition outlined in Equation 1 below must be met:

$${T}_{valid} > {T}_{ULTX} , \qquad Equation 1.$$

where T_{ULTX} is a time required to communicate the uplink data with the NTN apparatus 754. The uplink data may be communicated to the NTN apparatus 754 as part of a data transmission which involves a sequence of sub-transmissions, for example, transmitting a scheduling request on PRACH, receiving a PDCCH and transmitting a PUSCH which includes the data. As such, the time required to communicate the data with the NTN apparatus includes the time taken for the sequence of transmissions required to communicate the uplink data.

In order to evaluate the condition outlined in Equation 1, the communications device 752 must determine T_{valid} and T_{ULTX}. As will be appreciated by one skilled in the art, the communications device 752 can estimate T_{ULTX} based on an estimate of a time taken to communicate the transmission or sub-transmission which actually carries the uplink data (for example, a PUSCH). An estimate of the time taken to communicate the transmission or sub-transmission which carries the uplink data to the NTN apparatus may be based on a measurement of a size of the transmission or sub-transmission which carries the data and an estimation of the conditions for communicating the data (explained in more detail below).

As will be appreciated from FIG. 8, the communications device 752 can determine T_{valid} from Equation 2 below:

$${T}_{valid} = {T}_{D} - ( {T}_{1} - {T}_{0} ) \qquad Equation 2.$$

In the example of FIG. 7 and FIG. 8, the time T₁ is known to the communications device 752 because it is the time at which the communications device 752 reads the second repetition 702b of the set 702 of repetitions of the first SIB. Furthermore, the times T_{D} and T₀ may be included in each repetition of the set 702 of repetitions of the first SIB. For example, the second repetition 702b may indicate times T_{D} and T₀ to the communications device 752. In other words, each of repetition in the set 702 of repetitions of the first SIB may indicate, in addition to ephemeris information of the NTN apparatus 754, the start time of the transmission of the ephemeris information T₀ and the ephemeris information validity duration T_{D}. Therefore, after reading the second repetition 702b of the set 702 of repetitions of the first SIB, the communications device 752 determines T_{valid} and T_{ULTX}, and determines whether or not the condition outlined in Equation 1 is met. The determination of T_{valid} and T_{ULTX} by the communications device 752 is represented in FIG. 7 by steps S760 and S762. It will be appreciated that the order of steps S760 and S762 may be changed.

Referring to FIG. 7, in step S764, the communications device 752 determines whether or not to commence the data transmission before the expiry time T₂. For example, if the condition outlined in Equation 1 is not met, the communications device 752 may determine to not commence the data transmission before the expiry time T₂. This prevents the data transmission from being interrupted by the communications device 752 transitioning to idle mode or declaring RLF in response to determining that the ephemeris information received by the communications device 752 is no longer valid. An example of this is described in FIG. 8 which illustrates a sub-transmission which carries the uplink data (PUSCH 708) as part of a data transmission transmitted when the communications device 752 is in poor coverage.

As will be appreciated by one skilled in the art, a time taken to transmit an uplink transmission in poor coverage is typically greater than a time taken to transmit an uplink transmission in good coverage. In this case, the communications device 752 estimates the time required to communicate the uplink data (T_{ULTX}) based on an estimate of a time required to communicate the PUSCH 708 in poor coverage which is represented by T_{UTLX_poor}. As shown in FIG. 8, the communications device 752 estimates that the time required to communicate the PUSCH 708 in poor coverage is greater than T_{valid}, and therefore that the condition outlined in Equation 1 is not met. Therefore, the communications device 752 determines that it does not have sufficient time to transmit the data transmission in poor coverage and may refrain from commencing the data transmission before the expiry time T₂.

By contrast, if the condition outlined in Equation 1 is met, the communications device 752 may commence the data transmission. An example of this is described in FIG. 8 which illustrates a sub-transmission which carries the uplink data (PUSCH 710) as part of the data transmission transmitted when the communications device 752 is in good coverage. In this case, the estimate of the time required to communicate the PUSCH 710 in good coverage by the communications device 752 is represented by T_{ULTX_good}. As shown in FIG. 8, the communications device 752 estimates that the time required to communicate the PUSCH 710 in good coverage is less than T_{valid}, and therefore determines that the condition outlined in Equation 1 is met. Accordingly, the communications device 752 determines that it has sufficient time to transmit the data transmission in good coverage, and, in response the communications device 752 may transmit the data transmission to the NTN apparatus 754.

As explained above, communications efficiency can be improved if a communications device only commences a data transmission (such as a sporadic short transmission) if it is confident that the sporadic short transmission can be completed before a validity timer expires. One solution, as discussed above, is for the communications device to estimate T_{ULTX} and T_{valid} and to determine whether the condition outlined in Equation 1 is met. However, current approaches to estimating T_{ULTX} are based on measurements performed by the communications device and are subject to assumptions of conditions at the eNB such as the Signal-to-Noise Ratio (SNR) at the eNB, scheduling decisions at the eNB and a signalling load at the eNB. As such, current approaches to estimating a time required to communicate a sporadic short transmission lack accuracy.

Example embodiments of the present technique which address technical problems such as those described above will now be discussed.

### Biasing Signal

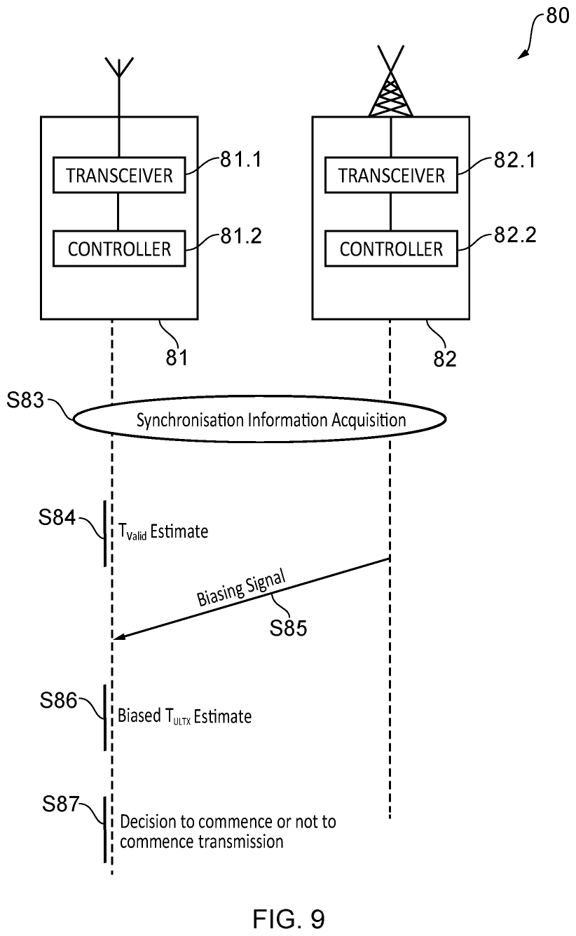

FIG. 9 is a part schematic, part message flow diagram representation of a wireless communications network 80 comprising a communications device 81 and an NTN apparatus 82 in accordance with embodiments of the present technique. The communications device 81 and the NTN apparatus 82 shown in FIG. 9 may broadly correspond to the communications device 752 and NTN apparatus 754 shown in FIG. 7.

As shown in FIG. 9, the communications device 81 and NTN apparatus 82 each comprise a transceiver (or transceiver circuitry) 81.1, 82.1 and a controller (or controller circuitry) 81.2, 82.2. Each of the controllers 81.2, 82.2 may be, for example, a microprocessor, a CPU, or a dedicated chipset, etc. The transceivers (or transceiver circuitry) 81.1, 82.1 of one or both of the communications device 81 and NTN apparatus 82 may comprise both a transmitter and a receiver, or may—instead of being a transceiver—be a standalone transmitter and receiver pair. It would be appreciated by those skilled in the art that the NTN apparatus 82 (as well as in some arrangements the communications device 81 and any other NTN apparatus, infrastructure equipment, or communications devices operating in accordance with embodiments of the present technique) may comprise a plurality of (or at least, one or more) transceivers (or transceiver circuitry) 81.1, 82.1.

Specifically, as is shown in step S83 of FIG. 8, the transceiver circuitry 81.1 and the controller circuitry 81.2 of the communications device 81 are configured in combination to acquire information for synchronising a transmission with the NTN apparatus 82. The information for synchronising a transmission with the NTN apparatus 82 may include one or more of: ephemeris information of the NTN apparatus, common timing advance (TA) parameters or a location of the communications device 81. For example, in some embodiments, the communications device 81 may receive ephemeris information from the NTN apparatus 82 as the information for synchronising the transmission with the NTN apparatus 82. In other embodiments, the communications device 81 may determine its location as the information for synchronising the transmission with the NTN apparatus 82. The location of the communications device 81 may be determined based on Global Navigation Satellite System (GNSS) capabilities of the communications device 82 as will be appreciated by one skilled in the art. The location of a stationary communications device may alternatively be programmed or otherwise configured in the communications device.

The transmission with the NTN apparatus 82 is one of an uplink transmission to be transmitted to the NTN apparatus 82, a downlink transmission to be received from the NTN apparatus 82, and a sequence of uplink and downlink transmissions to be communicated between the communications device 81 and the NTN apparatus 82. For example, the transmission with the NTN apparatus 82 may be a sporadic short transmission.

As shown in step S84, the transceiver circuitry 81.1 and the controller circuitry 81.2 of the communications device 81 are configured in combination to estimate a time remaining (for example, T_{valid}) until an expiry time (for example, T₂) at which the information for synchronising the transmission with the apparatus will become invalid. For example, in some embodiments, ephemeris information may become invalid before updated ephemeris information is received by the communications device 81. In some embodiments, common TA parameters may become invalid at the expiry time. In other embodiments, location information of the communications device 81 may become invalid after a pre-defined timer expires. A length of such a pre-defined timer may be based on a speed of the communications device 81. For example, the length of the pre-defined timer may be longer when the communications device 81 has a lower speed and vice versa.

As shown in step S85, the transceiver circuitry 81.1 and the controller circuitry 81.2 of the communications device 81 are configured in combination to receive, from the NTN apparatus 82, a biasing signal providing an indication to the communications device 81 to bias an estimate of a time required to communicate the transmission with the NTN apparatus 82.

In some embodiments, the indication provided by the biasing signal includes a scaling factor which can be used by the communications device 81 to scale an estimate of the time required to communicate the transmission with the NTN apparatus 82. In some embodiments, the indication provided by the biasing signal includes a time offset which can be added to an estimate of the time required to communicate the transmission with the NTN apparatus 82.

As shown in step S86, the transceiver circuitry 81.1 and the controller circuitry 81.2 of the communications device 81 are configured in combination to determine, based at least in part on the indication provided by the biasing signal, the biased estimate of the time required to communicate the transmission with the NTN apparatus 82. For example, the communications device 81 may scale an estimate of the time required to communicate the transmission with the NTN apparatus 82 (for example, T_{ULTX}) by the scaling factor or may add a time offset to an estimate of the time required to communicate the transmission with the NTN apparatus 82. The determination of the biased estimate may involve modifying or updating an previous estimate of the time required to communicate the transmission with the NTN apparatus 82 determined by the communications device 81 (for example, modifying or updating an estimate calculated according to Equation 3 below). The previous estimate of the time required to communicate the transmission with the NTN apparatus may be determined by the communications device based on a measurement of a size of the transmission with the NTN apparatus and an estimation of the conditions for communicating the transmission with the wireless communications network.

As shown in step S87, the transceiver circuitry 81.1 and the controller circuitry 81.2 of the communications device 81 are configured in combination to determine whether or not to commence the transmission with the NTN apparatus 82 before the expiry time based on the estimated time remaining until the expiry time and the biased estimate of the time required to communicate the transmission with the NTN apparatus 82. For example, the communications device 81 may determine to commence the transmission with the NTN apparatus 82 before the expiry time if the estimated time remaining until the expiry time exceeds the biased estimate of the time required to communicate the transmission with the NTN apparatus 82 and vice versa.

The biasing signal enables the wireless communications network to influence or modify an estimate of a time required to communicate the transmission with the NTN apparatus 82. The indication provided by the biasing signal may reflect network conditions such as signalling load in the wireless communications network, interference conditions in the wireless communications network, the occurrence of an emergency scenario and so on, as will be explained in more detail below. Therefore, through the biasing signal, the wireless communications network can influence the decision of whether or not to commence the transmission with the NTN apparatus before the expiry time. As will become apparent from the example embodiments described below, the above method can provide an increased communications efficiency in a non-terrestrial network.

Example embodiments will now be described where the transmission with the NTN apparatus 82 is an uplink transmission. However, it will be appreciated, as indicated above, that example embodiments are equally applicable in cases where the transmission with the NTN apparatus 82 is a downlink transmission or a sequence of uplink or downlink transmissions, or any type of sporadic short transmission.

For explanatory purposes, example embodiments described below are described with reference to the communications device 81, the NTN apparatus 82 and an eNB. However, references to “eNB” are equally applicable to any other infrastructure equipment such as a “gNB”. The eNB referred to in the example embodiments may form part of the NTN apparatus 82 or may be a terrestrial station which communicates with the communications device 81 via the NTN apparatus 82.

### eNB Signals Scaling Factor for Uplink Transmission

As explained above, a communications device 81 can estimate a time required to transmit an uplink transmission (such as a PUSCH) to the NTN apparatus 82 based on measurements performed by the communications device 81. For example, the communications device 81 may estimate T_{ULTX} based on Equation 3 below:

$${T}_{ULTX} = {N}_{REP} ⋆ {T}_{subframe} \qquad Equation 3.$$

In Equation 3, N_{P}r represents a number of subframes required to transmit an uplink transmission and T_{subframe} represents a time required to transmit one subframe. As will be appreciated by one skilled in the art, the value of T_{subframe} is known to the communications device 81 and for eMTC is approximately 1 ms.

A communications device 81 can calculate N_{REP} based on a measurement of a size of the uplink transmission and an estimation of the conditions for transmitting the uplink transmission to the eNB. For example, the calculation of N_{REP} may be based on one or more of a number of bits in the uplink transmission to be transmitted estimated by the communications device (alternatively, the communications device may know the number of bits in the uplink transmission as it can count the number of bits for transmission in its uplink transmit buffers), a pathloss between the communications device 81 and the eNB estimated by the communications device (for example, based on downlink reference signals received from the eNB, where the communications device can measure the received power of the reference signals and receive from the eNB an indication of the transmit power of those reference signals), and an indication of a noise or interference level at the eNB, where the noise or interference level can be signalled by the eNB or estimated by the communications device. The communications device may hence be able to estimate the signal to noise ratio, SNR, or signal to noise plus interference ration, SINR, at the eNB. Based on a known mapping between SNR/SINR and channel capacity or supportable code rate, the communications device can determine the number of subframes or overall time required to transmit the uplink data. Therefore, the calculation of N_{REP} is subject to assumptions of conditions at the eNB such as the Signal-to-Noise Ratio (SNR) at the eNB, scheduling decisions at the eNB and a signalling load at the eNB. Consequently, the calculation of T_{ULTX} is prone to inaccuracies. While N_{REP} can be considered to represent the number of repeated transmissions of a transport block, possibly with varying redundancy versions, it can more generally be considered to represent the number of subframes required to transmit uplink data.

In accordance with example embodiments, the communications device 81 may receive a biasing signal from an eNB which includes a scaling factor (SF) to bias an estimate of T_{ULTX}. For example, in accordance with example embodiments, the communications device 81 may calculate T_{ULTX} using Equation 4 below:

$${T}_{ULTX} = {N}_{REP} ⋆ {T}_{subframe} ⋆ SF \qquad Equation 4.$$

It will be appreciated from Equation 4 that the presence of a scaling factor can bias an estimate of a time taken for the communications device to communicate the uplink transmission with the NTN apparatus 82.

Furthermore, since the communications device 81 determines whether or not to commence the uplink transmission with the NTN apparatus 82 based on whether or not the condition outlined in Equation 1 is met, it will be appreciated that increasing the scaling factor biases the communications device 81 towards determining not to commence the uplink transmission with the NTN apparatus 82 before the expiry time, whereas decreasing the scaling factor biases the communication device 81 towards determining to commence the uplink transmission with the NTN apparatus 82 before the expiry time. It will be appreciated from example embodiments described below that an estimate of a time taken to communicate the uplink transmission with the NTN apparatus 82 can be biased to increase an accuracy of the estimate and/or to reflect preferences of the wireless communications network.

In some embodiments, the eNB determines the scaling factor based on a signalling load at the eNB. For example, an increased signalling load at the eNB may mean that the time required to successfully communicate the uplink transmission with the NTN apparatus is longer than that indicated by Equation 3. Accordingly, scenarios may arise where the communications device 81 determines to commence the uplink transmission based on the calculation of T_{ULTX} using Equation 3, even though the uplink transmission takes longer to transmit as a result of a large signalling load at the eNB. In such cases, the uplink transmission may be interrupted as explained above. In accordance with example embodiments, the eNB may assign a higher scaling factor when the signalling load at the eNB is higher compared with when the signalling load is lower. By basing the scaling factor on a signalling load at the eNB, the estimate of the time required to transmit the uplink transmission can be biased to provide a more accurate estimate of the time required to transmit the uplink transmission, which therefore improves communications efficiency by reducing a number of interrupted transmissions.

In some embodiments, there may be a scheduling delay between when the communications device 81 requests uplink resources for transmitting the uplink transmission to the NTN apparatus 82 and between the eNB scheduling the uplink resources for the communications device 81. In other words, the communications device 81 may initiate a connection with a wireless communications network before the wireless communications networks has assigned uplink resources to the communications device 81. In such embodiments, the eNB may determine the scaling factor based on the scheduling delay. For example, the eNB determines a larger scaling factor for a larger scheduling delay. By basing the scaling factor on a scheduling delay, the estimate of the time required to transmit the uplink transmission can be biased to provide a more accurate estimate of the time required to transmit the uplink transmission, which therefore improves communications efficiency by reducing a number of interrupted transmissions.

In some embodiments, the eNB may allocate the communications device 81 a plurality of instances of uplink resources for transmitting uplink transmissions. For example, the eNB may allocate the communications device 81 with a plurality of PUSCH instances, where each PUSCH instance is separated by a time gap and one or more of the PUSCH instances is allocated for the communications device 81 to transmit a portion of the uplink transmission with the NTN apparatus 82. During the time gaps between the PUSCH instances, the eNB 81 may allocate uplink or downlink resources for use by other communications devices in the coverage of the eNB. In such embodiments, the eNB may determine the scaling factor based on one or more of the time gaps between the allocated PUSCH instances. By accounting for the time gaps, the estimate of the time required to transmit the uplink transmission can be biased to provide a more accurate estimate of the time required to transmit the uplink transmission, which therefore improves communications efficiency by reducing a number of interrupted transmissions.

In some embodiments, the eNB may determine the scaling factor based on interference conditions at the eNB. More severe interference conditions at the eNB may mean that the time taken to successfully transmit the uplink transmission to the NTN apparatus 82 is increased compared with the estimate given by Equation 3. In some embodiments, the eNB may measure interference conditions at the eNB and determine the scaling factor based on the measured interference conditions. In one example, the eNB may determine that the scaling factor is greater if the measured interference conditions indicate that the interference conditions are more severe. By basing the scaling factor on measured interference conditions at the eNB, the estimate of the time required to transmit the uplink transmission can be biased to provide a more accurate estimate of the time required to transmit the uplink transmission, which therefore improves communications efficiency by reducing a number of interrupted transmissions.

In some embodiments, the eNB may determine the scaling factor based on a target residual error rate for the uplink transmission. For example, the eNB may prefer to receive one or more re-transmissions of the uplink transmission to reduce a residual error rate. Therefore, the eNB may determine that the scaling factor is greater in cases where a larger number of retransmissions are required to meet a target residual error rate and vice versa. By basing the scaling factor on a target residual error rate, the estimate of the time required to transmit the uplink transmission can be biased to reflect a preference of the eNB to receive the uplink transmission with a target residual error rate. Accordingly, the eNB may receive data in the transmissions with increased reliability.

As mentioned above, the communications device 81 may estimate the number of subframes N_{REP} to transmit the uplink transmission to the NTN apparatus 82 based on an estimate of a pathloss between the communications device 81 and the eNB. The pathloss between the communications device 81 and the eNB may be estimated based on one or more downlink reference signals received from the eNB. For example, the communications device 81 may estimate the pathloss between the communications device 81 and the eNB based on a measurement of a Reference Signal Received Power (RSRP) of one or more reference signals transmitted by the eNB. It will be appreciated by one skilled in the art that RSRP measurement is inaccurate in poor channel conditions. In accordance with example embodiments, the eNB may determine the scaling factor based on an assumption on the accuracy with which the communications device 81 measures the RSRP. For example, the eNB may determine a greater scaling factor when it assumes greater RSRP measurement inaccuracy and a smaller scaling factor when it assumes lower RSRP measurement inaccuracy. By basing the scaling factor on the accuracy with which the communications device 81 measures RSRP, the estimate of the time required to transmit the uplink transmission can be biased to provide a more accurate, or more conservative, estimate of the time required to transmit the uplink transmission, which therefore improves communications efficiency by reducing a number of interrupted transmissions.

In some embodiments, the eNB may determine the scaling factor based on whether or not the uplink transmission with the NTN apparatus 81 is an emergency transmission. For example, the eNB may detect that the uplink transmission is an emergency transmission and, in response, the eNB may decrease the scaling factor. In other words, the eNB biases the communications device 81 towards determining to commence the transmission of the uplink transmission with the NTN apparatus 82 before the expiry time.

In this way, the eNB recognises that it may be preferable to risk that the sporadic short transmission will exceed the expiry time than to prevent an emergency transmission. In other words, by basing the scaling factor on whether or not the uplink transmission is an emergency transmission, the estimate of the time required to transmit the uplink transmission can be biased to reflect a preference of the eNB to receive the uplink transmission even if the uplink transmission cannot be completed successfully.

In some embodiments, the eNB may determine the scaling factor based on a closed loop feedback of an interruption rate of previous transmissions with the NTN apparatus 82. The interruption rate may relate to the interruption rate observed from a group of communications devices in the cell or relate to the interruption rate observed from the communications device associated with the uplink transmission. In other words, the interruption rate can either be cell-based interruption rate or a UE-specific interruption rate. For example, if the eNB determines that a large number of transmissions with the NTN apparatus 82 are being interrupted, then the eNB may increase the scaling factor to bias the communications device 81 towards determining not to commence the uplink transmission before the expiry time. Conversely, if the eNB determines that a small number of transmissions are being interrupted, then the eNB may decrease the scaling factor to bias the communications device 81 towards determining to commence the uplink transmission before the expiry time. By basing the scaling factor on a closed loop feedback of an interruption rate of previous transmissions with the NTN apparatus 82, the estimate of the time required to transmit the uplink transmission to the NTN apparatus 82 can be biased to provide a more accurate estimate of the time required to transmit the uplink transmission, which therefore improves communications efficiency by reducing a number of interrupted transmissions.

### eNB Signals Time Offset for Uplink Transmission

In some embodiments, the biasing signal includes a time offset (T_{offset}). An estimate of the time taken to transmit the uplink transmission with the NTN apparatus 82 (T_{ULTX}) can be biased by adding the time offset, as will be appreciated from Equation 5 below.

$${T}_{ULTX} = {N}_{REP} ⋆ {T}_{subframe} + {T}_{offset} \qquad Equation 5.$$

In some embodiments, the biasing signal may include a scaling factor and a time offset such that the estimate of T_{ULTX} is biased by both the scaling factor and the time offset, as will be appreciated from Equation 6 below.

$${T}_{ULTX} = {N}_{REP} ⋆ SF ⋆ {T}_{subframe} + {T}_{offset} \qquad Equation 6.$$

The scaling factor in Equation 6 may be determined in accordance with any embodiment discussed above. Example embodiments of determining a biased estimate of the time taken required to communicate a transmission with the NTN apparatus 82 using the time offset will now be described, this biased estimate being computed in accordance with Equation 5 or Equation 6.

In some embodiments, the transmission with the NTN apparatus 82 includes a sequence of one or more uplink transmissions transmitted to the NTN apparatus 82 and a sequence of one or more downlink transmissions received from the NTN apparatus 82. The one or more downlink signals may be, for example, physical layer control signals such as physical downlink control channel signals, higher layer downlink signals such as downlink RRC signals or downlink application layer signals. In accordance with example embodiments, the eNB may determine the time offset to correspond to a time taken for the one or more downlink transmissions. For example, as explained above, the communications device 81 can be configured to estimate a number of bits in uplink transmissions to the NTN apparatus 82. However, as will be appreciated by one skilled in the art, the eNB can estimate a number of bits in the one or more downlink transmissions more accurately than the communications device 81. Therefore, by basing the time offset on the time taken for the one or more downlink transmissions, the estimate of the time required to communicate the transmission with the NTN apparatus 82 can be biased to improve an accuracy of the estimate of the time required to communicate the transmission with the NTN apparatus 82 by reducing a number of interrupted transmissions.

In some embodiments, the time offset may be determined by the eNB based on scheduling delay at the eNB. The scheduling delay may be a time period between the communications device 81 requesting resources for the transmission with the eNB and the eNB allocating the communications device 81 with the requested resources. By basing the time offset on the scheduling delay, the estimate of the time required to communicate the transmission with the NTN apparatus 82 can be biased to improve an accuracy of the estimate of the time required to communicate the transmission with the NTN apparatus 82 by reducing a number of interrupted transmissions.

### UE Changes its Uplink Transmission in Response to eNB Signalling

In some embodiments, the communications device 81 determines, based on the biasing signal received from the eNB, only to transmit part of a transmission with the NTN apparatus 82. For example, the communications device 81 may determine that an uplink transmission with the NTN apparatus 82 comprises at least two sets of data including a first set of data and a second set of data. For example, the first set of data may be a temperature reading and the second set of data may be an image. The communications may determine a number of bits required to transmit the first set of data and a number of bits required to transmit the second set of data. Based on the number of bits required to transmit the first set of data, and the biasing signal, the communications device may determine a biased estimate of a time required to transmit the first set of data to the NTN apparatus 82. Similarly, based on the number of bits required to transmit the second set of data, and the biasing signal, the communications device may determine a biased estimate of a time required to transmit the second set of data to the NTN apparatus 82. Then, the communications device 81 may determine, based on the biased estimate of the time required to transmit the first set of data, the biased estimate of the time required to transmit the second set of data, and the time remaining until the expiry time, whether to transmit the first set of data, the second set of data or both of the first and second set of data before the expiry time. For example, the communications device 81 may determine that there is only sufficient time remaining to transmit the first set of data and, in response, determines to commence the transmission of the first set of data before the expiry time and determines to refrain from transmitting the second set of data before the expiry time. In this case, the second set of data may transmitted at a later time, for example, as a further sporadic short transmission.

In some embodiments, the biased estimate of the time required to communicate the transmission with the NTN apparatus 82 may be based solely on the indication provided by the biasing signal. For example, the biasing signal may include an instruction to the communications device 81 to either commence or not commence the transmission with the NTN apparatus 82.

Those skilled in the art would further appreciate that such infrastructure equipment and/or communications devices as herein defined may be further defined in accordance with the various arrangements and embodiments discussed in the preceding paragraphs. It would be further appreciated by those skilled in the art that such infrastructure equipment and communications devices as herein defined and described may form part of communications systems other than those defined by the present disclosure.

The following numbered paragraphs provide further example aspects and features of the present technique:

Paragraph 1. A method of operating a communications device for transmitting signals to and/or receiving signals from a non-terrestrial network, NTN, apparatus of a wireless communications network, the method comprising
acquiring, by the communications device, information for synchronising a transmission with the NTN apparatus, the transmission with the NTN apparatus being one of an uplink transmission to be transmitted to the NTN apparatus, a downlink transmission to be received from the NTN apparatus, and a sequence of uplink and downlink transmissions to be communicated between the communications device and the NTN apparatus,
estimating, by the communications device, a time remaining until an expiry time at which the information for synchronising the transmission with the apparatus will become invalid,
receiving, from the NTN apparatus, a biasing signal providing an indication to the communications device to bias an estimate of a time required to communicate the transmission with the NTN apparatus,
determining, by the communications device, based at least in part on the indication provided by the biasing signal, the biased estimate of the time required to communicate the transmission with the NTN apparatus, and
determining, by the communications device, whether or not to commence the transmission with the NTN apparatus before the expiry time based on the estimated time remaining until the expiry time and the biased estimate of the time required to communicate the transmission with the NTN apparatus.

Paragraph 2. A method according to paragraph 1, wherein the indication provided by the biasing signal includes a scaling factor, and the determining the biased estimate of the time required to communicate the transmission with the NTN apparatus comprises scaling the estimate of the time required to communicate the transmission with the NTN apparatus by the scaling factor.

Paragraph 3. A method according paragraph 1 or paragraph 2, wherein the indication provided by the biasing signal includes a time offset, and the determining the biased estimate of the time required to communicate the transmission with the NTN apparatus comprises adding the time offset to the estimate of the time required to communicate the transmission with the NTN apparatus.

Paragraph 4. A method according to paragraph 3, wherein the indication provided by the biasing signal includes a scaling factor and the determining the biased estimate of the time required to communicate the transmission with the NTN apparatus comprises scaling the estimate of the time required to communicate the transmission with the NTN apparatus by the scaling factor and adding the time offset.

Paragraph 5. A method according to any of paragraphs 1 to 4, wherein the determining, by the communications device, whether or not to commence the transmission with the NTN apparatus before the expiry time comprises
determining, by the communications device, that the transmission with the NTN apparatus comprises at least two sets of data including a first set of data and a second set of data,
determining, based on the biased estimate of the time required to communicate the transmission with the NTN apparatus, a time required to transmit the first set of data, a time required to transmit the second set of data and a time required to transmit the first set of data and the second set of data and, in response,
determining whether to transmit the first set of data, the second set of data or both of the first and second set of data before the expiry time.

Paragraph 6. A method according to any of paragraphs 1 to 5, wherein the acquiring, by the communications device, information for synchronising a transmission with the NTN apparatus comprises receiving, by the communications device, ephemeris information of the NTN apparatus.

Paragraph 7. A method according to paragraph 6, wherein the receiving, by the communications device, ephemeris information of the NTN apparatus comprises
receiving, from the NTN apparatus, a set of system information blocks each of which includes a repeated transmission of the ephemeris information of the NTN apparatus,
determining, from one of the system information blocks in the set, the ephemeris information of the NTN apparatus.

Paragraph 8. A method according to paragraph 7, wherein the estimating the time remaining until the expiry time at which the information for synchronising the transmission with the apparatus will become invalid comprises
receiving, in the system information block from which the ephemeris information is determined, a duration for which the ephemeris information is valid and a time at which a first one of the set of system information blocks was transmitted, and
determining the time remaining until the expiry time based on the duration for which the ephemeris information is valid and a time at which a first one of the set of system information blocks was transmitted.

Paragraph 9. A method according to any of paragraphs 1 to 5, wherein the acquiring, by the communications device, information for synchronising a transmission with the NTN apparatus comprises
determining, by the communications device, a location of the communications device.

Paragraph 10. A method according to paragraph 5, wherein the determining, by the communications device, the location of the communications device comprises
determining the location of the communications device based on one or more signals received from a Global Navigation Satellite System, GNSS.

Paragraph 11. A method according to paragraph 5 or paragraph 6, wherein the estimating the time remaining until the expiry time at which the information for synchronising the transmission with the apparatus will become invalid comprises
determining, by the communications device, a speed of the communications device, and
estimating the time remaining until the expiry time based at least in part on the determined speed of the communications device.

Paragraph 12. A method according to any of paragraphs 1 to 11, wherein the communications device determines the biased estimate based on one or more of
a measurement of a size of the transmission with the NTN apparatus performed by the communications device, and
an estimation of the conditions for communicating the transmission with the NTN apparatus performed by the communications device.

Paragraph 13. A method according to paragraph 12, wherein the measurement of the size of the transmission with the NTN apparatus performed by the communications device is an estimation of a number of bits in the transmission with the NTN apparatus estimated by the communications device, and the estimation of the conditions for communicating the transmission with the NTN apparatus performed by the communications device includes one or more of a pathloss between the communications device and the wireless communications network estimated by the communications device and an estimation of noise or interference of the wireless communications network performed by the communications device.

Paragraph 14. A method according to paragraph 12 or paragraph 13, wherein the determining the biased estimate of the time required to communicate the transmission with the NTN apparatus comprises
determining, by the communications device, a previous estimate of a time required to communicate the transmission with the NTN apparatus based on and one or more of the measurement of the size of the transmission with the NTN apparatus performed by the communications device and the estimation of the conditions for communicating the transmission with the NTN apparatus performed by the communications device, and in response to receiving the biasing signal,
updating the previous estimate of the time required to communicate the transmission with the NTN apparatus based on the indication provided by the biasing signal to form the biased estimate of the time required to communicate the transmission with the NTN apparatus.

Paragraph 15. A method according to any of paragraphs 1 to 14, wherein the transmission with the NTN apparatus is a sporadic short transmission.
Paragraph 16. A method according to any of paragraphs 1 to 15, the method comprising determining, by the communications device, to commence the transmission with the NTN apparatus before the expiry time, and in response,
communicating the transmission with the NTN apparatus in accordance with the information for synchronising the transmission with the NTN apparatus.

Paragraph 17. A method of operating an infrastructure equipment forming part of a wireless communications network for transmitting signals to and/or receiving signals from a communications device via a non-terrestrial network, NTN, apparatus of the wireless communications network, the method comprising
determining, by the infrastructure equipment, to transmit, to the communications device via the NTN apparatus, a biasing signal providing an indication to the communications device to bias an estimate of a time required to communicate a transmission with the NTN apparatus, the transmission with the NTN apparatus being one of an uplink transmission to be transmitted to the NTN apparatus, a downlink transmission to be received from the NTN apparatus, and a sequence of uplink and downlink transmissions to be communicated between the communications device and the NTN apparatus, and
transmitting, by the infrastructure equipment, the biasing signal to the communications device via the NTN apparatus, wherein the indication provided by the biasing signal is used by the communications device to determine a biased estimate of a time required to communicate the transmission with the NTN apparatus to determine whether or not to commence the transmission with the NTN apparatus before an expiry time at which information acquired by the communications device for synchronising the transmission with the NTN apparatus becomes invalid.

Paragraph 18. A method according to paragraph 17, wherein the determining to transmit the biasing signal providing the indication to the communications device comprises
determining, by the infrastructure equipment, the indication provided by the biasing signal based on a signalling load in the wireless communications network.

Paragraph 19. A method according to paragraph 17 or paragraph 18, wherein the determining to transmit the biasing signal providing the indication to the communications device comprises
determining, by the infrastructure equipment, the indication provided by the biasing signal based on interference conditions in the wireless communications network.

Paragraph 20. A method according to any of paragraphs 17 to 19, wherein the determining to transmit the biasing signal providing the indication to the communications device comprises determining, by the infrastructure equipment, the indication provided by the biasing signal based on an error rate target set by the wireless communications network.

Paragraph 21. A method according to any of paragraphs 17 to 20, wherein the determining to transmit the biasing signal providing the indication to the communications device comprises determining, by the infrastructure equipment, the indication provided by the biasing signal based on an assumption of a reference signal received power, RSRP, accuracy of the communications device.

Paragraph 22. A method according to any of paragraphs 17 to 21, wherein the determining to transmit the biasing signal providing the indication to the communications device comprises
determining, by the infrastructure equipment, the indication provided by the biasing signal based on a detection, by the wireless communications network, that the transmission with the NTN apparatus is an emergency transmission.

Paragraph 23. A method according to any of paragraphs 17 to 22, wherein the determining to transmit the biasing signal providing the indication to the communications device comprises determining, by the infrastructure equipment, the indication provided by the biasing signal based on an interruption rate of previous transmissions with the NTN apparatus.

Paragraph 24. A method according to any of paragraphs 17 to 23, wherein the indication provided by the biasing signal includes a scaling factor to be used by the communications device to determine the biased estimate of the time required to communicate the transmission with the NTN apparatus by scaling the estimate of the time required to communicate the transmission with the NTN apparatus by the scaling factor, wherein the determining to transmit the biasing signal providing the indication to the communications device comprises determining the scale factor.

Paragraph 25. A method according to any of paragraphs 17 to 24, wherein the indication provided by the biasing signal includes a time offset to be used by the communications device to determine the biased estimate of the time required to communicate the transmission with the NTN apparatus by adding the time offset to the estimate of the time required to communicate the transmission with the NTN apparatus, wherein the determining to transmit the biasing signal providing the indication to the communications device comprises determining the time offset.

Paragraph 26. A method according to paragraph 25, wherein the indication provided by the biasing signal includes a scaling factor and the determining to transmit the biasing signal providing the indication to the communications device comprises determining the scaling factor and the timing offset.

Paragraph 27. A method according to paragraph 25 or paragraph 26, wherein the transmission with the NTN apparatus is a sequence of one or more uplink transmissions and one or more downlink transmissions, and the determining to transmit the biasing signal providing the indication to the communications device including the time offset comprises determining the time offset based on an estimate of a time required for receiving the one or more downlink transmissions from the NTN apparatus.

Paragraph 28. A method according to paragraph 25 or paragraph 26, wherein the time offset corresponds to a scheduling delay in the wireless communications network before the communications device is scheduled with an uplink transmission.

Paragraph 29. A communications device comprising
transceiver circuitry configured to transmit signals to and/or to receive signals from a non-terrestrial network, NTN, apparatus of a wireless communications network, and
controller circuitry configured in combination with the transceiver circuitry
to acquire information for synchronising a transmission with the NTN apparatus, the transmission with the NTN apparatus being one of an uplink transmission to be transmitted to the NTN apparatus, a downlink transmission to be received from the NTN apparatus, and a sequence of uplink and downlink transmissions to be communicated between the communications device and the NTN apparatus,
to estimate a time remaining until an expiry time at which the information for synchronising the transmission with the apparatus will become invalid,
to receive, from the NTN apparatus, a biasing signal providing an indication to the communications device to bias an estimate of a time required to communicate the transmission with the NTN apparatus,
to determine, based at least in part on the indication provided by the biasing signal, the biased estimate of the time required to communicate the transmission with the NTN apparatus, and
to determine whether or not to commence the transmission with the NTN apparatus before the expiry time based on the estimated time remaining until the expiry time and the biased estimate of the time required to communicate the transmission with the NTN apparatus.

Paragraph 30. Circuitry for a communications device comprising
transceiver circuitry configured to transmit signals to and/or to receive signals from a non-terrestrial network, NTN, apparatus of a wireless communications network, and controller circuitry configured in combination with the transceiver circuitry
to acquire information for synchronising a transmission with the NTN apparatus, the transmission with the NTN apparatus being one of an uplink transmission to be transmitted to the NTN apparatus, a downlink transmission to be received from the NTN apparatus, and a sequence of uplink and downlink transmissions to be communicated between the communications device and the NTN apparatus,
to estimate a time remaining until an expiry time at which the information for synchronising the transmission with the apparatus will become invalid,
   to receive, from the NTN apparatus, a biasing signal providing an indication to the communications device to bias an estimate of a time required to communicate the transmission with the NTN apparatus,
to determine, based at least in part on the indication provided by the biasing signal, the biased estimate of the time required to communicate the transmission with the NTN apparatus, and
to determine whether or not to commence the transmission with the NTN apparatus before the expiry time based on the estimated time remaining until the expiry time and the biased estimate of the time required to communicate the transmission with the NTN apparatus.

Paragraph 31. An infrastructure equipment forming part of a wireless communications network, the infrastructure equipment comprising
transceiver circuitry configured to transmit signals to and/or to receive signals from a communications device via a non-terrestrial network, NTN, apparatus of the wireless communications network, and
controller circuitry configured in combination with the transceiver circuitry
to determine to transmit, to the communications device via the NTN apparatus, a biasing signal providing an indication to the communications device to bias an estimate of a time required to communicate a transmission with the NTN apparatus, the transmission with the NTN apparatus being one of an uplink transmission to be transmitted to the NTN apparatus, a downlink transmission to be received from the NTN apparatus, and a sequence of uplink and downlink transmissions to be communicated between the communications device and the NTN apparatus, and
to transmit the biasing signal to the communications device via the NTN apparatus, wherein the indication provided by the biasing signal is used by the communications device to determine a biased estimate of a time required to communicate the transmission with the NTN apparatus to determine whether or not to commence the transmission with the NTN apparatus before an expiry time at which information acquired by the communications device for synchronising the transmission with the NTN apparatus becomes invalid.

Paragraph 32. Circuitry for an infrastructure equipment forming part of a wireless communications network, the circuitry comprising
transceiver circuitry configured to transmit signals to and/or to receive signals from a communications device via a non-terrestrial network, NTN, apparatus of the wireless communications network, and
controller circuitry configured in combination with the transceiver circuitry
to determine to transmit, to the communications device via the NTN apparatus, a biasing signal providing an indication to the communications device to bias an estimate of a time required to communicate a transmission with the NTN apparatus, the transmission with the NTN apparatus being one of an uplink transmission to be transmitted to the NTN apparatus, a downlink transmission to be received from the NTN apparatus, and a sequence of uplink and downlink transmissions to be communicated between the communications device and the NTN apparatus, and
to transmit the biasing signal to the communications device via the NTN apparatus, wherein the indication provided by the biasing signal is used by the communications device to determine a biased estimate of a time required to communicate the transmission with the NTN apparatus to determine whether or not to commence the transmission with the NTN apparatus before an expiry time at which information acquired by the communications device for synchronising the transmission with the NTN apparatus becomes invalid.

Paragraph 33. A wireless communications system comprising a communications device according to Paragraph 29 and an infrastructure equipment according to Paragraph 31.

Paragraph 34. A computer program comprising instructions which, when loaded onto a computer, cause the computer to perform a method according to Paragraph 1 or Paragraph 17.

35. A non-transitory computer-readable storage medium storing a computer program according to Paragraph 34.

In so far as embodiments of the disclosure have been described as being implemented, at least in part, by software-controlled data processing apparatus, it will be appreciated that a non-transitory machine-readable medium carrying such software, such as an optical disk, a magnetic disk, semiconductor memory or the like, is also considered to represent an embodiment of the present disclosure.

It will be appreciated that the above description for clarity has described embodiments with reference to different functional units, circuitry and/or processors. However, it will be apparent that any suitable distribution of functionality between different functional units, circuitry and/or processors may be used without detracting from the embodiments.

Described embodiments may be implemented in any suitable form including hardware, software, firmware or any combination of these. Described embodiments may optionally be implemented at least partly as computer software running on one or more data processors and/or digital signal processors. The elements and components of any embodiment may be physically, functionally and logically implemented in any suitable way. Indeed, the functionality may be implemented in a single unit, in a plurality of units or as part of other functional units. As such, the disclosed embodiments may be implemented in a single unit or may be physically and functionally distributed between different units, circuitry and/or processors.

Although the present disclosure has been described in connection with some embodiments, it is not intended to be limited to the specific form set forth herein. Additionally, although a feature may appear to be described in connection with particular embodiments, one skilled in the art would recognise that various features of the described embodiments may be combined in any manner suitable to implement the technique.

### REFERENCES

[1] TR 38.811 V15.4.0, “Study on New Radio (NR) to support non terrestrial networks (Release 15)”, 3rd Generation Partnership Project, October 2020.
[2] Holma H. and Toskala A, “LTE for UMTS OFDMA and SC-FDMA based radio access”, John Wiley and Sons, 2009.
[3] TR 38.821 V16.0.0, “Solutions for NR to support Non-Terrestrial Networks (NTN)” 3rd Generation Partnership Project, January 2020.
[4] RP-202908, “Solutions for NR to support non-terrestrial networks (NTN)”, Thales, RANP #90e, December 2020.
[5] RP-193235, “New Study WID on NB-IoT/eMTC support for NTN”, MediaTek Inc. RANP #86, December 2019.
[6] TR 36.763, “Study on Narrow-Band Internet of Things (NB-IoT)/enhanced Machine Type Communication (eMTC) support for Non-Terrestrial Networks (NTN) (Release 17)”, 3^{rd} Generation Partnership Project, June 2021.
[7] R1-2110672 “3GPP TSG-RAN WG1 Agreements for Release-17 IoT NTN (post RAN1 #106-bis-e)”. RAN1 #106bis_e.
[8] R1-2109804. “Enhancement to time synchronisation for IoT-NTN”. Sony, RAN1 #106bis_e.

1. A method of operating a communications device for transmitting signals to and/or receiving signals from a non-terrestrial network, NTN, apparatus of a wireless communications network, the method comprising
acquiring, by the communications device, information for synchronising a transmission with the NTN apparatus, the transmission with the NTN apparatus being one of an uplink transmission to be transmitted to the NTN apparatus, a downlink transmission to be received from the NTN apparatus, and a sequence of uplink and downlink transmissions to be communicated between the communications device and the NTN apparatus,
estimating, by the communications device, a time remaining until an expiry time at which the information for synchronising the transmission with the apparatus will become invalid,
receiving, from the NTN apparatus, a biasing signal providing an indication to the communications device to bias an estimate of a time required to communicate the transmission with the NTN apparatus,
determining, by the communications device, based at least in part on the indication provided by the biasing signal, the biased estimate of the time required to communicate the transmission with the NTN apparatus, and
determining, by the communications device, whether or not to commence the transmission with the NTN apparatus before the expiry time based on the estimated time remaining until the expiry time and the biased estimate of the time required to communicate the transmission with the NTN apparatus.

2. A method according to claim 1, wherein the indication provided by the biasing signal includes a scaling factor, and the determining the biased estimate of the time required to communicate the transmission with the NTN apparatus comprises scaling the estimate of the time required to communicate the transmission with the NTN apparatus by the scaling factor.

3. A method according claim 1, wherein the indication provided by the biasing signal includes a time offset, and the determining the biased estimate of the time required to communicate the transmission with the NTN apparatus comprises adding the time offset to the estimate of the time required to communicate the transmission with the NTN apparatus.

4. A method according to claim 3, wherein the indication provided by the biasing signal includes a scaling factor and the determining the biased estimate of the time required to communicate the transmission with the NTN apparatus comprises scaling the estimate of the time required to communicate the transmission with the NTN apparatus by the scaling factor and adding the time offset.

5. A method according to claim 1, wherein the determining, by the communications device, whether or not to commence the transmission with the NTN apparatus before the expiry time comprises
determining, by the communications device, that the transmission with the NTN apparatus comprises at least two sets of data including a first set of data and a second set of data,
determining, based on the biased estimate of the time required to communicate the transmission with the NTN apparatus, a time required to transmit the first set of data, a time required to transmit the second set of data and a time required to transmit the first set of data and the second set of data and, in response,
determining whether to transmit the first set of data, the second set of data or both of the first and second set of data before the expiry time.

6. A method according to claim 1, wherein the acquiring, by the communications device, information for synchronising a transmission with the NTN apparatus comprises
receiving, by the communications device, ephemeris information of the NTN apparatus.

7. A method according to claim 6, wherein the receiving, by the communications device, ephemeris information of the NTN apparatus comprises
receiving, from the NTN apparatus, a set of system information blocks each of which includes a repeated transmission of the ephemeris information of the NTN apparatus,
determining, from one of the system information blocks in the set, the ephemeris information of the NTN apparatus.

8. A method according to claim 7, wherein the estimating the time remaining until the expiry time at which the information for synchronising the transmission with the apparatus will become invalid comprises
receiving, in the system information block from which the ephemeris information is determined, a duration for which the ephemeris information is valid and a time at which a first one of the set of system information blocks was transmitted, and
determining the time remaining until the expiry time based on the duration for which the ephemeris information is valid and a time at which a first one of the set of system information blocks was transmitted.

9. A method according to claim 1, wherein the acquiring, by the communications device, information for synchronising a transmission with the NTN apparatus comprises
determining, by the communications device, a location of the communications device.

10. A method according to claim 5, wherein the determining, by the communications device, the location of the communications device comprises
determining the location of the communications device based on one or more signals received from a Global Navigation Satellite System, GNSS.

11. A method according to claim 5, wherein the estimating the time remaining until the expiry time at which the information for synchronising the transmission with the apparatus will become invalid comprises
determining, by the communications device, a speed of the communications device, and
estimating the time remaining until the expiry time based at least in part on the determined speed of the communications device.

12. A method according to claim 1, wherein the communications device determines the biased estimate based on one or more of
a measurement of a size of the transmission with the NTN apparatus performed by the communications device, and
an estimation of the conditions for communicating the transmission with the NTN apparatus performed by the communications device.

13. A method according to claim 12, wherein the measurement of the size of the transmission with the NTN apparatus performed by the communications device is an estimation of a number of bits in the transmission with the NTN apparatus estimated by the communications device, and the estimation of the conditions for communicating the transmission with the NTN apparatus performed by the communications device includes one or more of a pathloss between the communications device and the wireless communications network estimated by the communications device and an estimation of noise or interference of the wireless communications network performed by the communications device.

14. A method according to claim 12, wherein the determining the biased estimate of the time required to communicate the transmission with the NTN apparatus comprises
determining, by the communications device, a previous estimate of a time required to communicate the transmission with the NTN apparatus based on and one or more of the measurement of the size of the transmission with the NTN apparatus performed by the communications device and the estimation of the conditions for communicating the transmission with the NTN apparatus performed by the communications device, and in response to receiving the biasing signal,
updating the previous estimate of the time required to communicate the transmission with the NTN apparatus based on the indication provided by the biasing signal to form the biased estimate of the time required to communicate the transmission with the NTN apparatus.

15. A method according to claim 1, wherein the transmission with the NTN apparatus is a sporadic short transmission.

16. A method according to claim 1, the method comprising
determining, by the communications device, to commence the transmission with the NTN apparatus before the expiry time, and in response,
communicating the transmission with the NTN apparatus in accordance with the information for synchronising the transmission with the NTN apparatus.

17.-28. (canceled)

29. A communications device comprising
transceiver circuitry configured to transmit signals to and/or to receive signals from a non-terrestrial network, NTN, apparatus of a wireless communications network, and
controller circuitry configured in combination with the transceiver circuitry
to acquire information for synchronising a transmission with the NTN apparatus, the transmission with the NTN apparatus being one of an uplink transmission to be transmitted to the NTN apparatus, a downlink transmission to be received from the NTN apparatus, and a sequence of uplink and downlink transmissions to be communicated between the communications device and the NTN apparatus,
to estimate a time remaining until an expiry time at which the information for synchronising the transmission with the apparatus will become invalid,
to receive, from the NTN apparatus, a biasing signal providing an indication to the communications device to bias an estimate of a time required to communicate the transmission with the NTN apparatus,
to determine, based at least in part on the indication provided by the biasing signal, the biased estimate of the time required to communicate the transmission with the NTN apparatus, and
to determine whether or not to commence the transmission with the NTN apparatus before the expiry time based on the estimated time remaining until the expiry time and the biased estimate of the time required to communicate the transmission with the NTN apparatus.

30. (canceled)

31. An infrastructure equipment forming part of a wireless communications network, the infrastructure equipment comprising
transceiver circuitry configured to transmit signals to and/or to receive signals from a communications device via a non-terrestrial network, NTN, apparatus of the wireless communications network, and
controller circuitry configured in combination with the transceiver circuitry
to determine to transmit, to the communications device via the NTN apparatus, a biasing signal providing an indication to the communications device to bias an estimate of a time required to communicate a transmission with the NTN apparatus, the transmission with the NTN apparatus being one of an uplink transmission to be transmitted to the NTN apparatus, a downlink transmission to be received from the NTN apparatus, and a sequence of uplink and downlink transmissions to be communicated between the communications device and the NTN apparatus, and
to transmit the biasing signal to the communications device via the NTN apparatus, wherein the indication provided by the biasing signal is used by the communications device to determine a biased estimate of a time required to communicate the transmission with the NTN apparatus to determine whether or not to commence the transmission with the NTN apparatus before an expiry time at which information acquired by the communications device for synchronising the transmission with the NTN apparatus becomes invalid.

32.-35. (canceled)
